(19) United States
(12) Patent Application Publication
(10) Pub. No.: US 2025/0150394 A1
(43) Pub. Date: May 8, 2025

(54) BANDWIDTH CONTROL DEVICE, BANDWIDTH CONTROL METHOD, BANDWIDTH CONTROL PROGRAM, AND NETWORK SYSTEM

(71) Applicant: Nippon Telegraph and Telephone Corporation, Tokyo (JP)

(72) Inventor: Takayuki NAKAMURA, Musashino-shi, Tokyo (JP)

(21) Appl. No.: 18/833,429

(22) PCT Filed: Feb. 7, 2022
(86) PCT No.: PCT/JP2022/004754

§ 371 Date: Jul. 26, 2024

(51) Int. Cl. H04L 47/12

(52) U.S. Cl. CPC H04L 47/12

(57) ABSTRACT

Provided are a bandwidth control device, a bandwidth control method, a bandwidth control program, and a network system for improving reliability of a VPN. A measurement result holding unit acquires and holds, for each pair of a source and a destination of communication through a WAN, a measurement value of a transmission traffic volume to the WAN and a measurement value of a reception traffic volume in the destination. In a case where a difference obtained for the each pair by subtracting the reception traffic volume from the transmission traffic volume is equal to or larger than a threshold, a control determination unit sets the measurement value of the reception traffic volume as a limit value and performs limitation such that the limited transmission traffic volume falls within the limit value.

### TECHNICAL FIELD

The present invention relates to a bandwidth control device, a bandwidth control method, a bandwidth control program, and a network system.

### BACKGROUND ART

In recent years, a virtual private network (VPN) has attracted attention as a service provided for users by telecommunications carriers. The VPN is a technique of virtually separating a communication network for each user by using a technique such as a local area network (LAN) or multi-protocol label switching (MPLS) and distributing traffic of each user in each virtual network. The VPN is frequently used when highly confidential communication is performed between bases of companies in particular.

Further, securing reliability of the communication network is one of important services for the telecommunications carriers. For example, the telecommunications carriers are required to perform maintenance when a failure occurs and to quickly eliminate congestion. The same applies to communication using the VPN.

As a congestion elimination technique in the VPN, there has conventionally been proposed a technique of, when congestion occurs in a link, reducing a rate of traffic output to a provider network that a telecommunications carrier of a router accommodating each base has on the basis of a weight allocated to each base. Further, the technique can secure a minimum bandwidth of communication between bases. As a secondary effect of the technique, it is possible to prevent invalid traffic from flowing into the provider network. The invalid traffic herein refers to, among pieces of traffic that have passed through the provider network and then reached the router accommodating each base, traffic that is discarded due to transfer processing performance of the router or due to congestion of an interface (IF) bandwidth connected to the base of the router.

### CITATION LIST

### Non Patent Literature

Non Patent Literature 1: Masayoshi Shimamura, Katsuyoshi Iida, Hiroyuki Koga, Youki Kadobayashi, Suguru Yamaguchi, “Provisioning algorithm for minimum throughput assurance service in VPNs using nonlinear programming”, Technical Committee on Information Networks, Institute of Electronics, Information and Communication Engineers, Vol. 107, No. 249, pp. 35-40, October 2007

### SUMMARY OF INVENTION

### Technical Problem

However, the technique of reducing a rate of traffic on the basis of a weight allocated to each base performs limitation on congestion in the IF bandwidth of the router. Therefore, even by using the technique, it is difficult to suppress occurrence of invalid traffic due to congestion caused by the transfer processing performance. Further, the technique increases an amount of reduction stepwise until occurrence of congestion is suppressed. As described above, in order to calculate an appropriate amount of reduction, calculation is repeatedly performed until the amount of reduction converges into a certain value. Thus, even by using the technique, it is difficult to quickly deal with occurrence of invalid traffic. Therefore, the conventional congestion elimination technique cannot sufficiently deal with occurrence of invalid traffic, which makes it difficult to improve reliability of the VPN.

The present invention has been made in view of the above, and an object thereof is to improve reliability of the VPN.

### Solution to Problem

In order to solve the above problems and achieve the object, a measurement result holding unit acquires and holds, for each pair of a source and a destination of communication through a predetermined network, a measurement value of a transmission traffic volume to a predetermined network and a measurement value of a reception traffic volume in the destination. In a case where a difference obtained for the each pair by subtracting the reception traffic volume from the transmission traffic volume is equal to or larger than a threshold, a control determination unit sets the measurement value of the reception traffic volume as a limit value and performs limitation such that the limited transmission traffic volume falls within the limit value.

### Advantageous Effects of Invention

According to the present invention, it is possible to improve reliability of the VPN.

### BRIEF DESCRIPTION OF DRAWINGS

FIG. 1 is a system configuration diagram of a network system according to an embodiment.

FIG. 2 is a block diagram of a network system including details of a gateway control device and VPN gateways.

FIG. 3 illustrates a part of traffic transmitted and received in a network system.

FIG. 4 shows an example of notification content from a measurement result notification unit to a gateway control device.

FIG. 5 shows an example of notification content from a gateway control device to a limit setting unit.

FIG. 6 shows an example of held information held by a measurement result holding unit.

FIG. 7 shows an example of notification content of a limit setting from a control determination unit to a control instruction unit.

FIG. 8 shows an example of notification content of limit removal from a control determination unit to a control instruction unit.

FIG. 9 illustrates an overview of control of an output traffic volume in a case where congestion occurs.

FIG. 10 is a flowchart of bandwidth limitation processing by a gateway control device according to an embodiment.

FIG. 11 illustrates an example of a computer that executes a bandwidth control program.

### DESCRIPTION OF EMBODIMENTS

Hereinafter, embodiments of a bandwidth control device, a bandwidth control method, a bandwidth control program, and a network system disclosed in the present application will be described in detail with reference to the drawings. Note that the bandwidth control device, the bandwidth control method, the bandwidth control program, and the network system disclosed in the present application are not limited by the following embodiments.

### [Configuration of Network System]

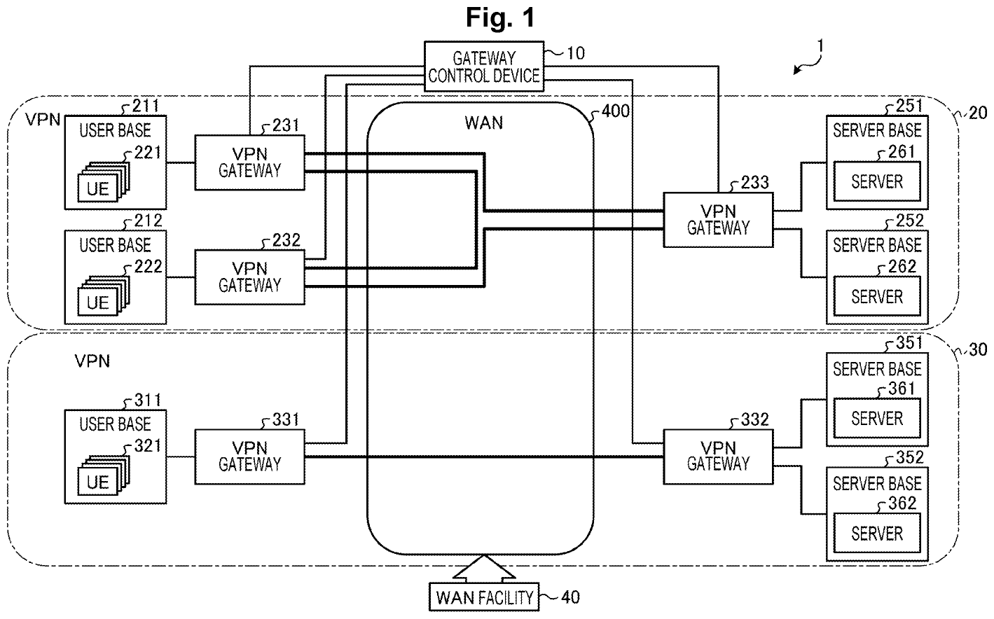

FIG. 1 is a system configuration diagram of a network system according to an embodiment. A configuration of a network system 1 according to the present embodiment will be described with reference to FIG. 1. The network system 1 includes a gateway control device 10, a world area network (WAN) facility 40, and a WAN 400. The network system 1 further includes a user base 211 including a plurality of pieces of use equipment (UE) 221, a user base 212 including a plurality of pieces of UE 222, and a user base 311 including a plurality of pieces of UE 321. The network system 1 further includes VPN gateways 231, 232, 233, 331, and 332. The network system 1 further includes a server base 251 in which a server 261 is arranged, a server base 252 in which a server 262 is arranged, a server base 351 in which a server 361 is arranged, and a server base 352 in which a server 362 is arranged.

The user bases 211 and 212, the VPN gateways 231, 232, and 233, and the server bases 251 and 252 form a VPN 20. The VPN gateway 231, the VPN gateway 232, and the VPN gateway 233 are connected by logical paths indicated by thick lines superimposed on the WAN 400. The VPN gateway 231, the VPN gateway 232, and the VPN gateway 233 communicate with each other via the logical paths.

Each piece of the UE 221 in the user base 211 is connected to the VPN gateway 231 via a network of the user base 211. Each piece of the UE 222 in the user base 212 is connected to the VPN gateway 232 via a network of the user base 212. The server 261 is connected to the VPN gateway 233 via a network of the server base 251. The server 262 is connected to the VPN gateway 233 via a network of the server base 252.

The user base 211 communicates with the server bases 251 and 252 via the VPN gateways 231 and 233. The user base 212 communicates with the server bases 251 and 252 via the VPN gateways 232 and 233. The user base 211 and the user base 212 communicate with each other via the VPN gateways 231 and 232.

The user base 311, the VPN gateways 331 and 332, and the server bases 351 and 352 form a VPN 30. The VPN gateway 331 and the VPN gateway 332 are connected by a logical path indicated by a thick line superimposed on the WAN 400. The VPN gateway 331 and the VPN gateway 332 communicate with each other via the logical path therebetween.

Each piece of the UE 321 in the user base 311 is connected to the VPN gateway 331 via a network of the user base 311. The server 361 is connected to the VPN gateway 332 via a network of the server base 351. The server 362 is connected to the VPN gateway 332 via a network of the server base 352. The user base 311 communicates with the server bases 351 and 352 via the VPN gateways 331 and 332.

The WAN 400 is a provider network and corresponds to an example of a predetermined network. The WAN facility 40 includes various devices that manage the WAN 400. The WAN facility 40 is shared by the VPNs 20 and 30. The WAN facility 40 superimposes the logical paths between the VPN gateway 231, the VPN gateway 232, and the VPN gateway 233 on the WAN 400. The WAN facility 40 further superimposes the logical path between the VPN gateway 331 and the VPN gateway 332 on the WAN 400.

The gateway control device 10 is a bandwidth control device. The gateway control device 10 is connected to each of the VPN gateways 231, 232, 331, 233, and 332. The gateway control device 10 predicts and detects occurrence of congestion by using a transmission traffic volume and a reception traffic volume of each of the VPN gateways 231, 232, 331, 233, and 332. The transmission traffic volume herein is an output traffic volume output toward the WAN 400. The reception traffic volume is an output traffic volume output toward each of the user bases 211, 212, and 311 or each of the server bases 251, 252, 351, and 352. Further, the gateway control device 10 suppresses occurrence of congestion by controlling a communication bandwidth of a source in a logical path in which the occurrence of the congestion has been predicted, thereby suppressing inflow of invalid traffic into the WAN 400. Details of the gateway control device 10 will be described below.

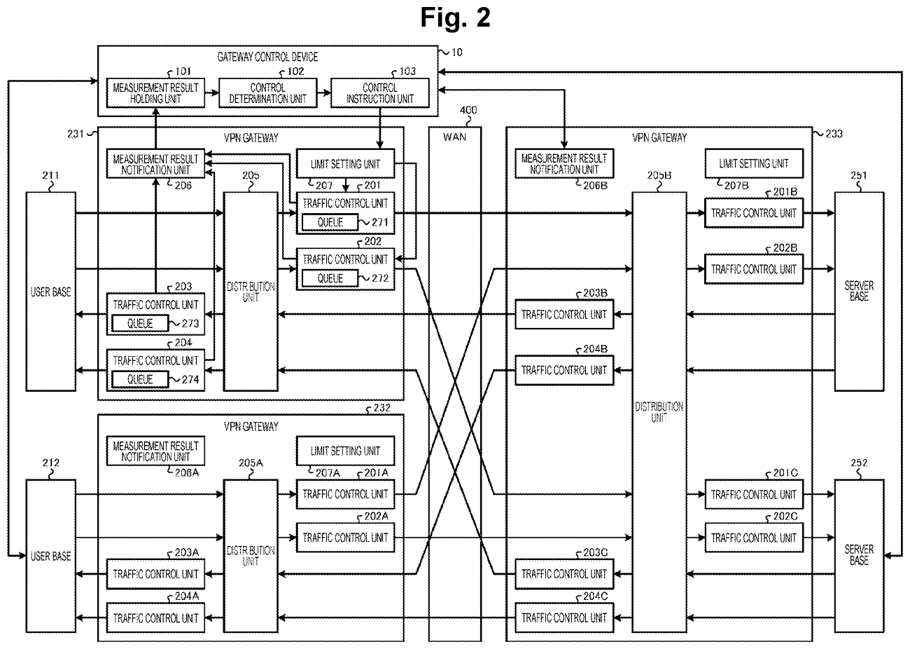

FIG. 2 is a block diagram of a network system including details of the gateway control device and the VPN gateways. Here, communication between the user bases 211 and 212 and the server bases 251 and 252 in the VPN 20 of FIG. 1 will be described as an example.

The VPN gateway 231 includes traffic control units 201 to 204, a distribution unit 205, a measurement result notification unit 206, and a limit setting unit 207. The VPN gateway 232 includes traffic control units 201A to 204A, a distribution unit 205A, a measurement result notification unit 206A, and a limit setting unit 207A. The VPN gateway 233 includes traffic control units 201B to 204B and 201C to 204C, a distribution unit 205B, a measurement result notification unit 206B, and a limit setting unit 207B.

The VPN gateways 231, 232, and 233 have the same function. Specifically, the traffic control units 201 and 202 have a similar function to the traffic control units 201A, 202A, 203B, 204B, 203C, and 204C. The traffic control units 203 and 204 have a similar function to the traffic control units 203A, 204A, 201B, 202B, 201C, and 202C. The distribution unit 205 has a similar function to the distribution units 205A and 205B. The measurement result notification unit 206 has a similar function to the measurement result notification units 206A and 206B. The limit setting unit 207 has a similar function to the limit setting units 207A and 207B. Because those units have similar functions as described above, the VPN gateway 231 will be described as an example. In a case where the VPN gateways 231 to 233 are not distinguished from each other, the VPN gateways 231 to 233 will be referred to as “VPN gateways 200”.

The traffic control unit 201 and the traffic control unit 203 are arranged as a pair in output directions, i.e., in a base direction and a WAN direction, for traffic between the user base 211 and the server base 251. Similarly, the traffic control unit 202 and the traffic control unit 204 are arranged as a pair in the output directions, i.e., in the base direction and the WAN direction, for traffic between the user base 211 and the server base 252. Here, two pairs are arranged because the two server bases 251 and 252 are taken as examples of communication partners. However, the pairs are arranged according to the number of destinations. For example, in FIG. 1, the user base 212 also exists as a communication partner of the user base 211. Thus, a pair is arranged for traffic between the user base 211 and the user base 212.

The traffic control unit 201 controls traffic from the user base 211 toward the server base 251. The traffic control unit 201 has a queue 271. The traffic control unit 201 measures the output traffic volume that is the volume of traffic output from the queue 271 toward the WAN 400, i.e., the transmission traffic volume. Then, the traffic control unit 201 outputs the measured output traffic volume to the measurement result notification unit 206.

In a case where the output traffic volume is controlled to suppress congestion of the traffic from the user base 211 toward the server base 251, the traffic control unit 201 receives setting of a limit value of the output traffic volume from the limit setting unit 207. Then, the traffic control unit 201 limits output of the traffic from the queue 271 such that the output traffic volume falls within the set limit value.

The traffic control unit 202 controls traffic from the user base 211 toward the server base 252. The traffic control unit 202 has a queue 272. The traffic control unit 202 measures the output traffic volume that is the volume of traffic output from the queue 272 toward the WAN 400, i.e., the transmission traffic volume. Then, the traffic control unit 202 outputs the measured output traffic volume to the measurement result notification unit 206.

In a case where the output traffic volume is controlled to suppress congestion of the traffic from the user base 211 toward the server base 252, the traffic control unit 202 receives setting of a limit value of the output traffic volume from the limit setting unit 207. Then, the traffic control unit 202 limits output of the traffic from the queue 272 such that the output traffic volume falls within the set limit value.

The traffic control unit 203 controls traffic from the server base 251 toward the user base 211. The traffic control unit 203 has a queue 273. The traffic control unit 203 measures the output traffic volume that is the volume of traffic output from the queue 273 toward the user base 211, i.e., the reception traffic volume. Then, the traffic control unit 203 outputs the measured output traffic volume to the measurement result notification unit 206.

The traffic control unit 204 controls traffic from the server base 252 toward the user base 211. The traffic control unit 204 has a queue 274. The traffic control unit 204 measures the output traffic volume that is the volume of traffic output from the queue 274 toward the user base 211, i.e., the reception traffic volume. Then, the traffic control unit 204 outputs the measured output traffic volume to the measurement result notification unit 206.

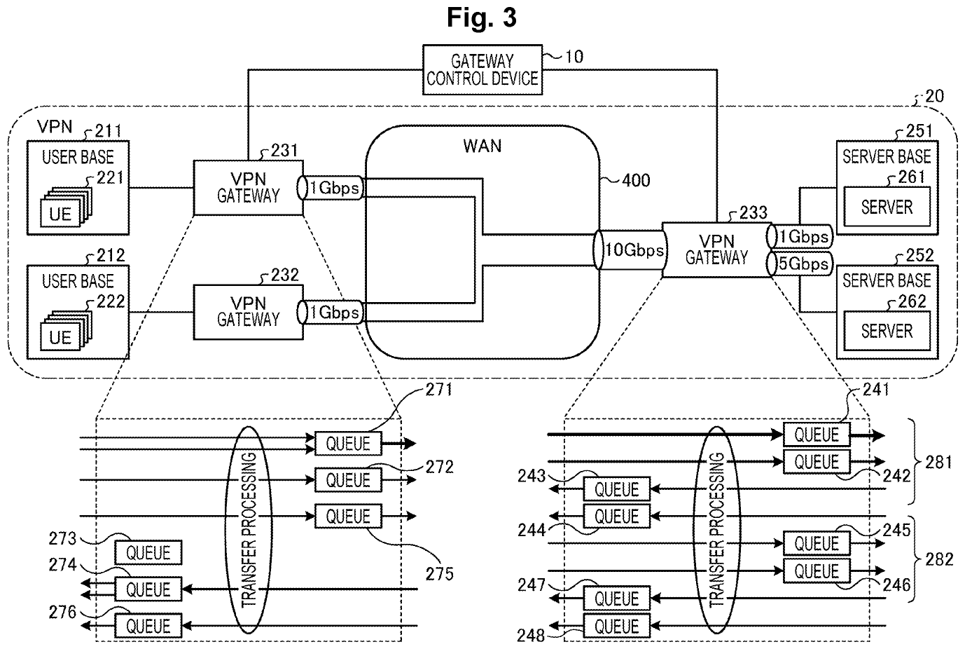

FIG. 3 illustrates a part of traffic transmitted and received in the network system. Here, traffic transmitted and received by the VPN gateways 231 and 233 will be described. For example, the VPN gateway 231 has a communication bandwidth of 1 Gbps with the WAN 400. The VPN gateway 232 has a communication bandwidth of 1 Gbps with the WAN 400. The VPN gateway 233 has a communication bandwidth of 1 Gbps with the server base 251 and a communication bandwidth of 5 Gbps with the server base 252.

The VPN gateway 231 stores the traffic transmitted from the user base 211 toward the server base 251 in the queue 271 and transmits the traffic toward the VPN gateway 233 through the WAN 400. For example, as illustrated in FIG. 3, pieces of traffic transmitted from the plurality of pieces of the UE 221 toward the server 261 are stored in the queue 271, and the pieces of traffic are collectively output from the queue 271 toward the WAN 400. The VPN gateway 231 also stores the traffic transmitted from the user base 211 toward the server base 252 in the queue 272 and transmits the traffic toward the VPN gateway 233 through the WAN 400. The VPN gateway 231 also stores traffic transmitted from the user base 211 toward the user base 212 in a queue 275 and transmits the traffic toward the VPN gateway 232 through the WAN 400.

The VPN gateway 233 receives, from the WAN 400, the traffic transmitted from the server base 251 toward the user base 211, stores the traffic in the queue 273, and transmits the traffic toward the user base 211. For example, as illustrated in FIG. 3, in a case where there is no traffic from the server 261 toward the UE 221, storing of traffic in the queue 273 or output of traffic from the queue 273 is not performed. The VPN gateway 231 receives, from the WAN 400, the traffic transmitted from the server base 252 toward the user base 211, stores the traffic in the queue 274, and transmits the traffic toward the user base 211. The VPN gateway 231 stores traffic transmitted from the user base 212 toward the user base 211 in a queue 276 and transmits the traffic toward the user base 211.

Here, a case where the VPN gateway 233 has queues 241 to 248 for transmitting traffic will be described. Traffic 281 flows to the server base 251. Traffic 282 flows to the server base 252.

The VPN gateway 233 receives, from the WAN 400, the traffic transmitted from the user base 211 toward the server base 251, stores the traffic in the queue 241, and transmits the traffic toward the server base 251. The VPN gateway 233 also receives, from the WAN 400, the traffic transmitted from the user base 212 toward the server base 251, stores the traffic in the queue 242, and transmits the traffic toward the server base 251. The VPN gateway 233 stores the traffic transmitted from the server base 251 toward the user base 211 in the queue 243 and transmits the traffic toward the VPN gateway 231 through the WAN 400. The VPN gateway 233 also stores the traffic transmitted from the server base 251 toward the user base 212 in the queue 244 and transmits the traffic toward the VPN gateway 232 through the WAN 400.

The VPN gateway 233 receives, from the WAN 400, the traffic transmitted from the user base 211 toward the server base 252, stores the traffic in the queue 245, and transmits the traffic toward the server base 252. The VPN gateway 233 also receives, from the WAN 400, the traffic transmitted from the user base 212 toward the server base 252, stores the traffic in the queue 246, and transmits the traffic toward the server base 252. The VPN gateway 233 stores the traffic transmitted from the server base 252 toward the user base 211 in the queue 247 and transmits the traffic toward the VPN gateway 231 through the WAN 400. The VPN gateway 233 also stores the traffic transmitted from the server base 252 toward the user base 212 in the queue 248 and transmits the traffic toward the VPN gateway 232 through the WAN 400.

Referring back to FIG. 2, the description will be continued. The measurement result notification unit 206 receives input of the output traffic volumes from the traffic control units 201 to 204. Then, the measurement result notification unit 206 notifies a measurement result holding unit 101 of the gateway control device 10 of measurement results of the output traffic volumes by the traffic control unit 201 to 204 at certain intervals. The certain interval herein can be, for example, an interval of five seconds. At this time, the measurement result notification unit 206 adds information regarding a source, destination, and output direction of the traffic passing through each of the traffic control units 201 to 204 and information regarding a VPN GW ID and issues the output traffic volume. The output direction is either the WAN direction or the base direction. In this case, the base direction is a direction toward the user base 211. The VPN GW ID is an identifier uniquely allocated to each of the VPN gateways 231, 232, 331, 233, and 332.

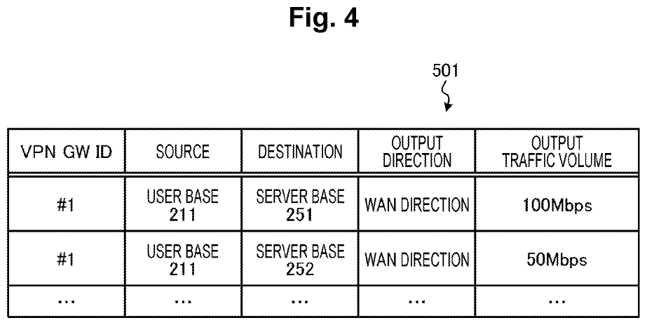

FIG. 4 shows an example of notification content from the measurement result notification unit to the gateway control device. Notification of the output traffic volume by the VPN gateway 231 will be described with reference to FIG. 4. Here, the VPN GW ID of the VPN gateway 231 is #1. In this case, the measurement result notification unit 206 transmits content shown in notification content 501 of FIG. 4 to the gateway control device 10. Specifically, the measurement result notification unit 206 issues #1 that is an identifier of the VPN gateway 231 as the VPN GW ID. Further, for the traffic toward the server base 251, the measurement result notification unit 206 issues the user base 211 as the source of the traffic, the server base 251 as the destination of the traffic, and the WAN direction as the output direction. The measurement result notification unit 206 issues 100 Mbps as the output traffic volume from the queue 271. Further, for the traffic toward the server base 252, the measurement result notification unit 206 issues the user base 211 as the source of the traffic, the server base 252 as the destination of the traffic, and the WAN direction as the output direction. The measurement result notification unit 206 issues 50 Mbps as the output traffic volume from the queue 272.

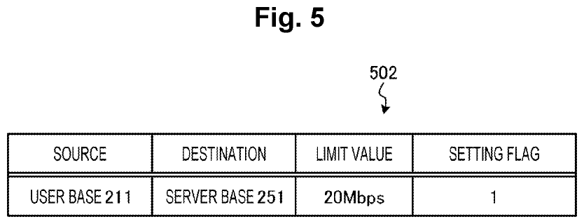

Referring back to FIG. 2, the description will be continued. The limit setting unit 207 receives a traffic control notification from the control instruction unit 103 of the gateway control device 10. FIG. 5 shows an example of notification content from the gateway control device to the limit setting unit. The limit setting unit 207 receives a traffic control notification including the source, the destination, the limit value, and a setting flag. The setting flag is information indicating a notification indicating setting of a limit or a notification indicating removal of the limit. Here, a setting flag “1” is a notification indicating setting of the limit, and a setting flag “0” is a notification indicating removal of the limit.

For example, a case where the limit value of 20 Mbps is set to the traffic from the user base 211 to the server base 251 will be described. As shown in notification content 502, the limit setting unit 207 receives a notification indicating the user base 211 as the source, the server base 251 as the destination, the limit value of 20 Mbps, and the setting flag “1”. In a case of a notification having the setting flag “0” and indicating cancellation of the setting, the limit setting unit 207 receives a notification of information indicating a blank such as “-” as a setting value.

In response to the notification received from the gateway control device 10, the limit setting unit 207 extracts the traffic control unit 200 matching with a target source/destination and having the WAN direction as the output direction. For example, when receiving a notification of the notification content 502 in FIG. 5, the limit setting unit 207 extracts the traffic control unit 201 having the user base 211 as the source, the server base 251 as the destination, and the WAN 400 as the output direction. Then, in a case where the setting flag is “1”, the limit setting unit 207 sets the limit value of the output traffic volume to the extracted traffic control unit 200, and, in a case where the setting flag is “0”, the limit setting unit 207 cancels the setting of the limit value. For example, when receiving the notification of the notification content 502 in FIG. 5, the limit setting unit 207 sets the output traffic volume of 20 Mbps to the traffic control unit 201.

Referring back to FIG. 2, the description will be continued. The distribution unit 205 receives input of traffic input to the VPN gateway 231 from the user base 211 or the WAN 400. Then, the distribution unit 205 determines bases of the source and destination of the input traffic in accordance with information such as a destination IP address and a source IP address included in the traffic. Then, the distribution unit 205 distributes the traffic to any one of the traffic control units 201 to 204 in accordance with the determination result.

For example, transfer processing in FIG. 3 corresponds to an example of processing performed by the distribution unit 205. The distribution unit 205 distributes the traffic input from the user base 211 to any one of the queues 271, 272, and 275. The distribution unit 205 also distributes the traffic input from the WAN 400 to any one of the queues 273, 274, and 276. The distribution unit 205B distributes the traffic input from the WAN 400 to any one of the queues 241, 242, 245, and 246. The distribution unit 205B also distributes the traffic input from the server base 251 or 252 to any one of the queues 243, 244, 247, and 248.

Next, the gateway control device 10 will be described. The gateway control device 10 includes the measurement result holding unit 101, a control determination unit 102, and the control instruction unit 103.

The measurement result holding unit 101 receives a notification of the output traffic volumes measured by the traffic control units 201 to 204 from the measurement result notification unit 206 of the VPN gateway 231. The measurement result holding unit 101 similarly receives a notification of the output traffic volumes from the VPN gateway 232 and the VPN gateway 233. Then, the measurement result holding unit 101 holds content of the notification from each of the VPN gateways 231, 232, and 233.

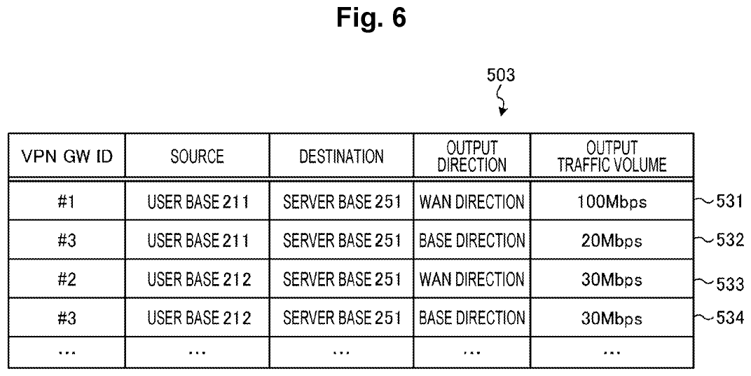

FIG. 6 shows an example of held information held by the measurement result holding unit. Here, the VPN GW ID of the VPN gateway 232 is #2, and the VPN GW ID of the VPN gateway 233 is #3. As shown in held information 503 of FIG. 6, the measurement result holding unit 101 holds the source, destination, and output direction of the traffic corresponding to each output traffic volume and the output traffic volume in association with the VPN GW ID of the source.

As described above, the measurement result holding unit 101 acquires and holds, for each pair of the source and the destination of communication through the WAN 400, a measurement value of the transmission traffic volume to the WAN 400 and a measurement value of the reception traffic volume in the destination.

Referring back to FIG. 2, the description will be continued. The control determination unit 102 checks the held information held by the measurement result holding unit 101 at predetermined intervals. The predetermined interval herein may be the same as or different from the notification interval by the measurement result notification unit 206 of the VPN gateway 200. The predetermined interval can be, for example, five seconds, which is the same as the notification interval of the measurement result notification unit 206 of the VPN gateway 200. Then, based on content of the held information held by the measurement result holding unit 101, the control determination unit 102 calculates, for each pair of the source and the destination, a difference obtained by subtracting the output traffic volume in the base direction from the output traffic volume in the WAN direction, i.e., a difference obtained by subtracting the reception traffic volume from the transmission traffic volume.

Next, the control determination unit 102 determines whether or not, among the calculated differences, there is a difference equal to or larger than a predetermined congestion determination threshold for each calculation result having the same destination. In this case, sources of the calculation results may be different. The congestion determination threshold can be set to, for example, a value at which congestion is expected to occur when the difference is statistically equal to or larger than the value. For example, the congestion determination threshold can be 10 Mpbs. Then, in a case where there is a difference equal to or larger than the congestion determination threshold, the control determination unit 102 determines that congestion will occur or has occurred in the destination. Hereinafter, the expression “congestion has occurred” includes a case where the congestion will occur.

The control determination unit 102 performs the following processing for traffic toward a destination where congestion has occurred in order to limit the output traffic volume to the WAN 400. The control determination unit 102 selects one source from pieces of data having the destination where the congestion has occurred as the destination in the held information held by the measurement result holding unit 101. In this case, the control determination unit 102 selects the source regardless of the magnitude of the difference. That is, because the congestion has already occurred in the destination, the control determination unit 102 limits data transmission to the destination as a whole in order to eliminate the congestion.

The control determination unit 102 acquires, from the held information held by the measurement result holding unit 101, data of the traffic from the selected source to the destination where the congestion has occurred. Here, as the data of the traffic, the control determination unit 102 acquires two pieces of data, i.e., data from the VPN gateway 200 accommodating the source and data from the VPN gateway 200 accommodating the destination.

Next, the control determination unit 102 extracts, from the selected data of the traffic, the output traffic volume whose output direction is the base direction and the VPN GW ID of the VPN gateway 200 accommodating the selected source. The output traffic volume whose output direction is the base direction herein is the output traffic volume toward the destination where the congestion has occurred, the output traffic volume being measured by the VPN gateway 200 accommodating the destination where the congestion has occurred, and is the reception traffic volume.

Next, the control determination unit 102 notifies the control instruction unit 103 of information indicating the selected source, the destination where the congestion has occurred, the output traffic volume in the base direction, the extracted VPN GW ID, and the exceeding flag “1”. Further, the control determination unit 102 records the destination where the congestion has occurred as a congestion occurrence base, records the information regarding the selected source and the extracted VPN GW ID, and records the output traffic volume in the base direction as the limit value.

In a case where there is a plurality of sources for the traffic toward the destination where the congestion has occurred, the control determination unit 102 repeats the similar processing for limiting the output traffic volume by the number of sources.

For example, the processing for limiting the output traffic volume, which is performed by the control determination unit 102, in a case where the held information 503 in FIG. 6 is held by the measurement result holding unit 101 will be described. The control determination unit 102 calculates a difference between the WAN direction and the base direction in pieces of traffic data 531 and 532 whose source is the user base 211 and destination is the server base 251 as 100−20=80. The control determination unit 102 also calculates a difference between the WAN direction and the base direction in pieces of traffic data 533 and 534 whose source is the user base 212 and destination is the server base 251 as 30−30=0. Here, for example, in a case where the congestion determination threshold is 10 Mbps, the difference in traffic represented by the pieces of data 531 and 532 is equal to or larger than the congestion determination threshold. Therefore, the control determination unit 102 determines that congestion has occurred in the server base 251.

Next, the control determination unit 102 selects the user base 211 as the source of the traffic. Next, the control determination unit 102 acquires the pieces of traffic data 531 and 532 whose source is the user base 211. Next, the control determination unit 102 acquires, from the data 532, 20 Mbps that is the output traffic volume in the base direction. The control determination unit 102 also extracts #1 that is the VPN GW ID of the VPN gateway 231 accommodating the user base 211.

Further, the control determination unit 102 selects, as the source of the traffic, the user base 212 having a small difference in the output traffic volume. Next, the control determination unit 102 acquires the pieces of traffic data 533 and 534 whose source is the user base 212. Next, the control determination unit 102 acquires, from the data 534, 30 Mbps that is the output traffic volume in the base direction. The control determination unit 102 extracts #2 that is the VPN GW ID of the VPN gateway 232 accommodating the user base 212.

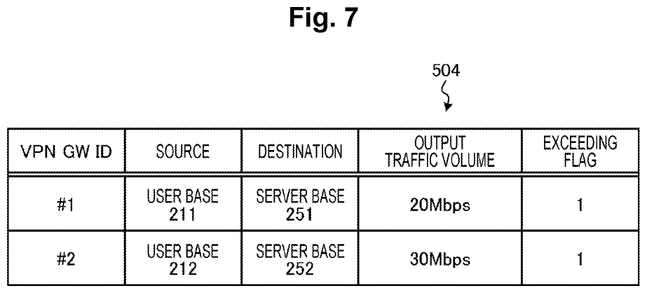

FIG. 7 shows an example of notification content of a limit setting from the control determination unit to the control instruction unit. The control determination unit 102 notifies the control instruction unit 103 of notification content 504 in FIG. 7. For the user base 211, the control determination unit 102 issues #1 as the extracted VPN GW ID, issues the user base 211 as the source, and issues the server base 251 as the destination where the congestion has occurred. The control determination unit 102 further issues 20 Mbps as the output traffic volume in the base direction and issues information indicating the exceeding flag “1”. Further, for the user base 212, the control determination unit 102 issues #2 as the extracted VPN GW ID, issues the user base 212 as the source, and issues the server base 252 as the destination where the congestion has occurred. The control determination unit 102 further issues 30 Mbps as the output traffic volume in the base direction and issues information indicating the exceeding flag “1”.

The control determination unit 102 records, as the congestion occurrence base, the server base 251 that is the destination where the congestion has occurred. The control determination unit 102 further records the user base 211 as the source, #1 as the VPN GW ID, and 20 Mbps as the limit value. Similarly, the control determination unit 102 records the user base 212 as the source, #2 as the VPN GW ID, and 30 Mbps as the limit value.

As described above, in a case where, for each pair of the source and the destination of communication through a predetermined network, a difference obtained by subtracting the measurement value of the reception traffic volume from the measurement value of the transmission traffic volume is equal to or larger than the threshold, the control determination unit 102 sets the measurement value of the reception traffic volume as the limit value and performs limitation such that the limited transmission traffic volume falls within the limit value. Further, for each pair in which the destination in the pair having the difference equal to or larger than the threshold is the destination of itself, the control determination unit 102 sets the measurement value of the reception traffic volume as the limit value and performs limitation such that the limited transmission traffic volume falls within the limit value.

The control determination unit 102 performs the following determination on the traffic having the recorded congestion occurrence base as the destination. The control determination unit 102 determines whether or not, among pieces of traffic having each base as the source, there is traffic whose difference in the output traffic volume between the WAN direction and the base direction is less than the congestion determination threshold and output traffic volume in the WAN direction is less than the limit value. In traffic having any base as the source, in a case where the difference in the output traffic volume falls below the congestion determination threshold, and the output traffic volume in the WAN direction is less than the limit value, the control determination unit 102 determines that the congestion having the destination as the congestion occurrence base has been eliminated.

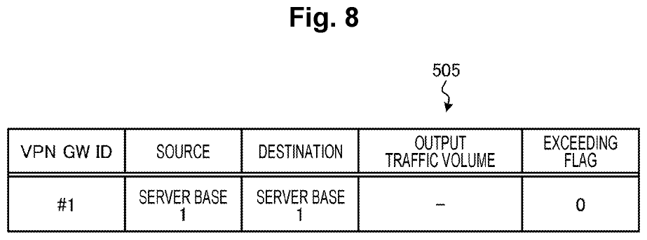

Then, as shown in notification content 505 of FIG. 8, the control determination unit 102 notifies the control instruction unit 103 of information indicating the destination where the congestion has been eliminated, the source whose output traffic volume of the traffic toward the destination is limited, and the exceeding flag “0”. FIG. 8 shows an example of notification content of limit removal from the control determination unit to the control instruction unit. In this case, the limit on the output traffic volume is eliminated, and thus notification of the output traffic volume may not be performed as shown in the notification content 505. In a case where there is a plurality of sources whose output traffic volume of the traffic is limited, the control determination unit 102 issues a notification to the control instruction unit 103 for each of the sources. Thereafter, the control determination unit 102 deletes, from the recorded congestion occurrence base, information regarding the destination where removal of the limit has been issued.

As described above, in a case where the difference is less than the threshold, and the transmission traffic volume is less than the limit value, the control determination unit 102 removes the limitation for the pair of the source and the destination of the communication through the WAN 400 on which the limitation has been performed.

The control instruction unit 103 receives a notification regarding the limitation of the output traffic volume from the control determination unit 102. Then, in a case where the exceeding flag included in the notification is “1”, the control instruction unit 103 notifies the VPN gateway 200 matching with the VPN GW ID specified in the notification of an instruction to limit the output traffic volume. Specifically, the control instruction unit 103 transmits a notification indicating the limit value of the output traffic volume in the WAN direction and the setting flag “1” together with the information regarding the source and the destination specified in the notification.

Meanwhile, in a case where the exceeding flag included in the notification is “0”, the control instruction unit 103 notifies the VPN gateway 200 matching with the VPN GW ID specified in the notification of an instruction to remove the limitation of the output traffic volume. Specifically, the control instruction unit 103 transmits a notification indicating the setting flag “0” and a blank limit value together with the information regarding the source and the destination specified in the notification.

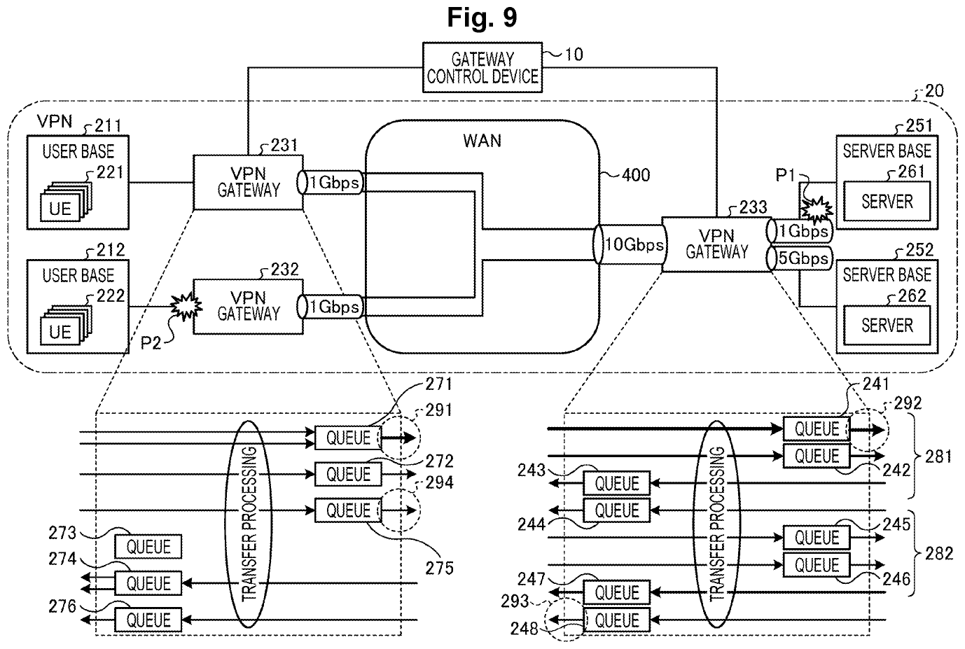

FIG. 9 illustrates an overview of control of the output traffic volume in a case where congestion occurs. FIG. 9 illustrates a state in which congestion has occurred in the traffic transmitted and received by the VPN gateways 231, 232, and 233 in FIG. 3. There are other sources whose output traffic volume is limited, but here, an overall overview of a limitation procedure of the output traffic volume in a case where only the user base 211, the server base 251, and the server base 252 are sources will be described.

The gateway control device 10 obtains a difference between the output traffic volume of the VPN gateway 233 in the base direction and the output traffic volume of the VPN gateway 231 in the WAN direction in the traffic transmitted from the user base 211 toward the server base 251. Then, because the difference is equal to or larger than the congestion determination threshold, the gateway control device 10 determines that congestion P1 has occurred in the server base 251 serving as the destination of the traffic. Due to the congestion P1, packet loss occurs in a packet to be transmitted to the server base 251.

In this case, the gateway control device 10 selects the user base 211 as one of the sources of the traffic whose destination is the server base 251. Then, the gateway control device 10 sets an output traffic volume 292 from the queue 241 toward the server base 251 as the limit value and limits an output traffic volume 291 from the queue 271 toward the WAN 400.

The gateway control device 10 obtains a difference between the output traffic volume of the VPN gateway 232 in the base direction and the output traffic volume of the VPN gateway 233 in the WAN direction in the traffic transmitted from the server base 252 toward the user base 212. Then, because the difference is equal to or larger than the congestion determination threshold, the gateway control device 10 determines that congestion P2 has occurred in the user base 212 serving as the destination of the traffic. Due to the congestion P2, packet loss occurs in a packet to be transmitted to the user base 212.

In this case, the gateway control device 10 selects the user base 211 as one of the sources of the traffic whose destination is the user base 212. Then, the gateway control device 10 sets the output traffic volume from the VPN gateway 232 in the traffic from the user base 211 to the user base 212 as the limit value and limits an output traffic volume 294 from the queue 275 toward the WAN 400. Further, the gateway control device 10 selects the server base 252 as one of the sources of the traffic whose destination is the user base 212. Then, the gateway control device 10 sets the output traffic volume from the VPN gateway 232 in the traffic from the server base 252 toward the user base 212 as the limit value and limits an output traffic volume 293 from the queue 248 toward the WAN 400.

### [Bandwidth Limitation Processing]

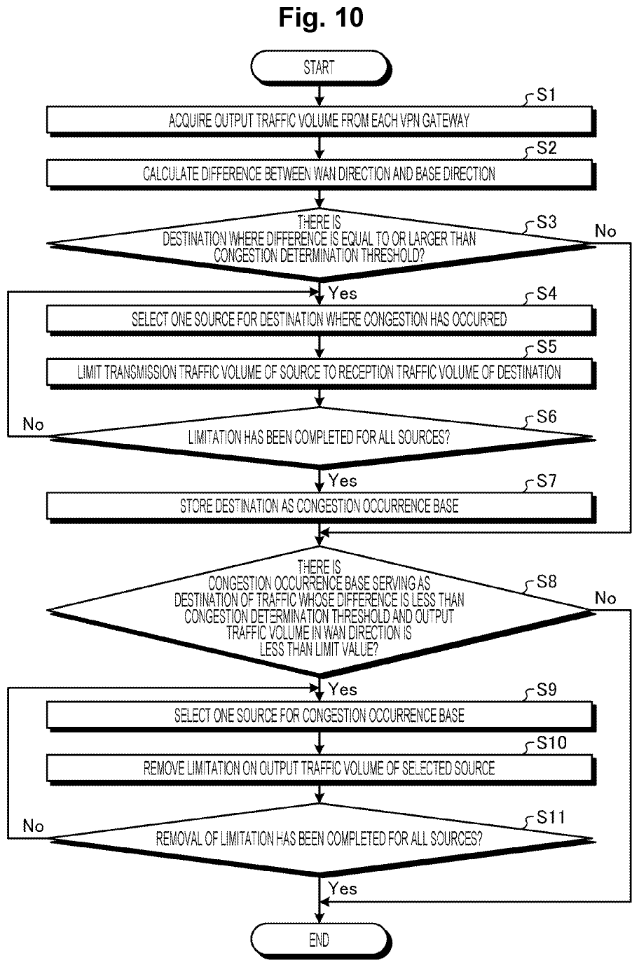

FIG. 10 is a flowchart of bandwidth limitation processing by the gateway control device according to the embodiment. An overall flow of the bandwidth limitation processing by the gateway control device 10 according to the present embodiment will be described with reference to FIG. 10.

The measurement result holding unit 101 acquires an output traffic volume from each VPN gateway 200 and holds the output traffic volume as held information (step S1).

The control determination unit 102 refers to the held information held by the measurement result holding unit 101 and calculates a difference between the output traffic volume in the WAN direction and the output traffic volume in the base direction in each piece of traffic for each pair of the source and the destination (step S2).

Next, the control determination unit 102 determines whether or not there is a destination where the obtained difference is equal to or larger than the congestion determination threshold (step S3). When there is no destination where the difference is equal to or larger than the congestion determination threshold (step S3: No), the bandwidth control processing proceeds to step S8.

Meanwhile, when there is a destination where the difference is equal to or larger than the congestion determination threshold (step S3: Yes), the control determination unit 102 determines that congestion has occurred in the destination. Then, the control determination unit 102 selects one source for the destination where the congestion has occurred (step S4).

Next, the control determination unit 102 notifies the control instruction unit 103 of an instruction to perform control by using the limit value of the output traffic volume in the WAN direction from the VPN gateway 200 accommodating the source as the output traffic volume to the destination from the VPN gateway 200 accommodating the destination. The control instruction unit 103 notifies the VPN gateway 200 accommodating the selected source of the limit value and limits the output traffic volume from the selected source to the destination to the limit value. That is, the control instruction unit 103 limits the transmission traffic volume of the selected source to the reception traffic volume of the destination (step S5).

Next, the control determination unit 102 determines whether or not limitation of the output traffic volume has been completed for all the sources with respect to the destination where the congestion has occurred (step S6). When there remains a source where the output traffic volume has not been limited (step S6: No), the bandwidth control processing returns to step S4.

Meanwhile, when the limitation of the output traffic volume has been completed for all the sources (step S6: Yes), the control determination unit 102 stores the destination where the congestion has occurred as the congestion occurrence base (step S7).

Next, the control determination unit 102 determines whether or not there is a congestion occurrence base serving as a destination of traffic whose difference is less than the congestion determination threshold and output traffic volume in the WAN direction is less than the limit value (step S8).

Next, when there is no congestion occurrence base serving as a destination of traffic whose difference is less than the congestion determination threshold and output traffic volume in the WAN direction is less than the limit value (step S8: No), the gateway control device 10 ends the bandwidth control processing.

Meanwhile, when there is a congestion occurrence base serving as a destination of traffic whose difference is less than the congestion determination threshold and output traffic volume in the WAN direction is less than the limit value (step S8: Yes), the control determination unit 102 performs the following processing. The control determination unit 102 selects one source for the congestion occurrence base (step S9).

Next, the control determination unit 102 notifies the control instruction unit 103 of removal of the limitation on the output traffic volume from the selected source to the congestion occurrence base. The control instruction unit 103 instructs the VPN gateway 200 accommodating the selected source to remove the limitation on the output traffic volume from the selected source to the congestion occurrence base, thereby removing the limitation (step S10).

Thereafter, the control determination unit 102 determines whether or not the removal of the limitation has been completed for all the sources with respect to the congestion occurrence base (step S11). When there is a source where the removal of the limitation has not been performed (step S11: No), the bandwidth control processing returns to step S9.

Meanwhile, when the removal of the limitation has been completed for all the sources (step S11: Yes), the gateway control device 10 ends the bandwidth control processing. The gateway control device 10 repeats the above bandwidth control processing every predetermined period.

### [Effects of Gateway Control Device]

As described above, the gateway control device 10 serving as the bandwidth control device according to the present embodiment determines that, in a case where a difference between the transmission traffic volume and the reception traffic volume in each piece of traffic is equal to or larger than the congestion determination threshold, congestion has occurred in a destination of the traffic. Then, the gateway control device 10 limits the transmission traffic volume to the reception traffic volume in the traffic between the destination where the congestion has occurred and each source for the destination.

This makes it possible to match the transmission traffic volume on the basis of a measurement value of the reception traffic volume and to suppress occurrence of invalid traffic to the WAN, such as traffic that has passed through the WAN but does not reach each base. Further, it is possible to suppress congestion caused by the transfer processing performance by limiting an invalid traffic volume in the source on the basis of a result showing a decrease in the reception traffic volume due to the congestion caused by the transfer processing performance. It is also possible to quickly deal with occurrence of the invalid traffic by calculating the limit value on the basis of the reception traffic volume. Therefore, the bandwidth control device according to the present embodiment can improve reliability of the VPN.

### [System Configuration and the Like]

Each component of each device in the drawings is functionally conceptual and does not necessarily need to be physically configured as illustrated in the drawings. That is, a specific form of distribution and integration of each device is not limited to the illustrated form, and all or some thereof can be functionally or physically distributed or integrated in any unit depending on various loads, use status, and the like. Further, all or some of processing functions performed in the respective devices can be implemented by a central processing unit (CPU) and a program analyzed and executed by the CPU or may be implemented as hardware by wired logic.

Among pieces of processing described in the present embodiment, all or some of the pieces of processing described as being automatically performed can be manually performed, or all or some of the pieces of processing described as being manually performed can be automatically performed by a known method. Further, the processing procedures, the control procedures, the specific names, and the information including various kinds of data and parameters in the above document and drawings can be arbitrarily changed unless otherwise specified.

### [Program]

In an embodiment, the gateway control device 10 serving as the bandwidth control device can be implemented by installing a bandwidth control program for performing the above information processing as package software or online software in a desired computer. For example, when an information processing device is caused to execute the bandwidth control program, the information processing device can be caused to function as the gateway control device 10. The information processing device herein includes a desktop or a laptop personal computer. Further, examples of the information processing device include a mobile communication terminal such as a smartphone, a mobile phone, and a personal handy-phone system (PHS) and a slate terminal such as a personal digital assistant (PDA).

When a terminal device used by a user serves as a client, the bandwidth control device can also be implemented as a service providing device that provides the client with a service related to the above bandwidth control processing. For example, the bandwidth control device is implemented as a server device that provides a bandwidth control service for performing bandwidth control. In this case, the server device may be implemented as a web server or may be implemented as a cloud that provides a service related to the above bandwidth control processing by outsourcing.

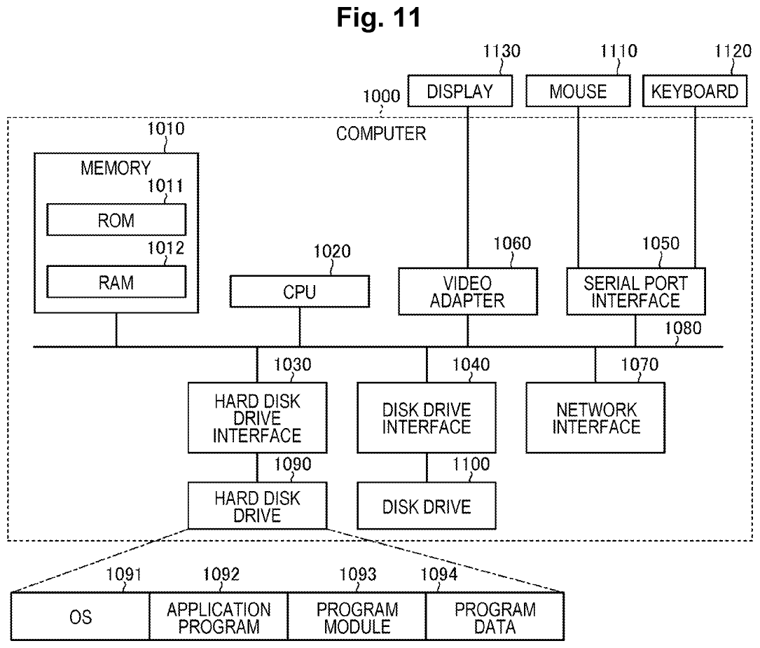

FIG. 11 illustrates an example of a computer that executes the bandwidth control program. A computer 1000 includes a memory 1010 and a CPU 1020, for example. The computer 1000 also includes a hard disk drive interface 1030, a disk drive interface 1040, a serial port interface 1050, a video adapter 1060, and a network interface 1070. Those units are connected by a bus 1080.

The memory 1010 includes a read only memory (ROM) 1011 and a random access memory (RAM) 1012. The ROM 1011 stores a boot program such as a basic input output system (BIOS), for example. The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to a mouse 1110 and a keyboard 1120, for example. The video adapter 1060 is connected to a display 1130, for example.

The hard disk drive 1090 stores, for example, an OS 1091, an application program 1092, a program module 1093, and program data 1094. That is, a classification program that defines each piece of processing of the gateway control device 10 having a function equivalent to that of the gateway control device 10 is implemented as the program module 1093 in which a code executable by a computer is written. The program module 1093 is stored in, for example, the hard disk drive 1090. For example, the program module 1093 for performing similar processing to that of the functional configuration of the gateway control device 10 is stored in the hard disk drive 1090. Note that the hard disk drive 1090 may be replaced with a solid state drive (SSD).

Setting data used in the processing of the above embodiment is stored in, for example, the memory 1010 or the hard disk drive 1090 as the program data 1094. The CPU 1020 reads the program module 1093 and the program data 1094 stored in the memory 1010 or the hard disk drive 1090 to the RAM 1012 as necessary and performs the processing of the above embodiment.

Note that the program module 1093 and the program data 1094 are not limited to being stored in the hard disk drive 1090 and may be stored in, for example, a removable storage medium and be read by the CPU 1020 via the disk drive 1100 or the like. Alternatively, the program module 1093 and the program data 1094 may be stored in another computer connected via a network (e.g. local area network (LAN) or wide area network (WAN)). The program module 1093 and the program data 1094 may be read by the CPU 1020 from another computer via the network interface 1070.

### REFERENCE SIGNS LIST

1 Network system
10 Gateway control device
20, 30 VPN
40 WAN facility
101 Measurement result holding unit
102 Control determination unit
103 Control instruction unit
201 to 204, 201A to 204A, 201B to 204B, 201C to 204C Traffic control unit
205, 205A, 205B Distribution unit
206, 206A, 206B Measurement result notification unit
207, 207A, 207B Limit setting unit
211, 212, 311 User base
221, 222, 321 UE
200, 231, 232, 233, 331, 332 VPN gateway
251, 252, 351, 352 Server base
261, 262, 361, 362 Server
241 to 248, 271 to 276 Queue
400 WAN

1. A bandwidth control device comprising one or more processors configured to execute instructions that cause the bandwidth control device to perform operations comprising:
for each pair of a source and a destination of communication through a predetermined network, acquiring and holding a measurement value of a transmission traffic volume to the predetermined network and a measurement value of a reception traffic volume in the destination; and
in a case where a difference obtained for the each pair by subtracting the measurement value of the reception traffic volume from the measurement value of the transmission traffic volume is equal to or larger than a threshold, setting the measurement value of the reception traffic volume as a limit value and performs limitation such that the limited transmission traffic volume falls within the limit value.

2. The bandwidth control device according to claim 1, the operations further comprising
for the each pair in which the destination in the pair having the difference equal to or larger than the threshold is the destination of itself, setting the measurement value of the reception traffic volume as the limit value and performing limitation such that the limited transmission traffic volume falls within the limit value.

3. The bandwidth control device according to claim 1, the operations further comprising
in a case where the difference is less than the threshold, and the transmission traffic volume is less than the limit value, removing the limitation for the pair on which the limitation has been performed.

4. The bandwidth control device according to claim 1, the operations further comprising
for each pair of the source and the destination of the communication through a virtual network obtained by virtually separating the predetermined network, acquiring and holding the measurement value of the transmission traffic volume to the virtual network and the measurement value of the reception traffic volume in the destination.

5. A bandwidth control method comprising:
for each pair of a source and a destination of communication through a predetermined network, acquiring and holding a measurement value of a transmission traffic volume to the predetermined network and a measurement value of a reception traffic volume in the destination; and
in a case where a difference obtained for the each pair by subtracting the measurement value of the reception traffic volume from the measurement value of the transmission traffic volume is equal to or larger than a threshold, setting the measurement value of the reception traffic volume as a limit value and performing limitation such that the limited transmission traffic volume falls within the limit value.

6. A non-transitory computer-readable medium storing instructions that, upon such execution, cause one or more processors to perform operations comprising:
for each pair of a source and a destination of communication through a predetermined network, acquiring and holding a measurement value of a transmission traffic volume to the predetermined network and a measurement value of a reception traffic volume in the destination; and
in a case where a difference obtained for the each pair by subtracting the measurement value of the reception traffic volume from the measurement value of the transmission traffic volume is equal to or larger than a threshold, setting the measurement value of the reception traffic volume as a limit value and performing limitation such that the limited transmission traffic volume falls within the limit value.

7. (canceled)
